(19) United States
(12) Patent Application Publication
(10) Pub. No.: US 2003/0046104 A1
(43) Pub. Date: Mar. 6, 2003

(54) Method for the approval of expense applications

(75) Inventors: Yeun-Jonq Lee, Taipei (TW); Fang-Chen Tsao, Taipei (TW); Hao-Liang Chen, Taipei (TW)

Correspondence Address: DOUGHERTY & TROXELL, SUITE 1404, 5205 LEESBURG PIKE, FALLS CHURCH, VA, 22041, US

(73) Assignee: Via Technologies, Inc.

(21) Appl. No.: 10/212,780

(22) Filed: Aug. 7, 2002

(30) Foreign Application Priority Data
Aug. 29, 2001 (TW) 90121368

(51) Int. Cl. G06F 17/60

(52) U.S. Cl. 705/1

(57) ABSTRACT

The present invention disclosed a method for approving expense applications. It is applied in a computer system that has set up a procedure for approving expenses and comprises the following steps: submitting an expense application and personally checking it; entering it into the computer system if the expense application is approved, or returning it for resubmission if it is rejected; following up with a second check by the computer system; saving it on the computer system and creating a ledger for if the application information is approved by the computer system, or returning it for resubmission if it is rejected.

### FIELD OF THE INVENTION

The present invention relates to a method for approving expense applications, and more specifically, a method for approving expense applications to be applied in an Enterprise Resource Planning (ERP) system.

### BACKGROUND OF THE INVENTION

Generally, the process of approving expenses in a business begins with the department supervisor and ends with the accounting department providing the necessary double-checking. The majority of the conventional ERP systems do not provide a mechanism to control or approve expenses; therefore, the expenses, after approval of the supervisor, are always personally double-checked by the accounting department, and then entered into the ERP system.

Referring to FIG. 1, an example of the conventional process for the approving of expenses is illustrated as follows.

In FIG. 1, an applicant submits an expense application enclosed with related expense receipts (Step 102) for the department supervisor's review and approval (Step 104). If the expanse application is approved by the supervisor, it will be passed to the accounting department for double-checking (Step 106); otherwise, the documentation is returned to the applicant (Step 108) for resubmission. If the expanse application passes the double-checking, it will be entered into the ERP system to create a ledger (Step 110); otherwise, the documentation is returned to the applicant (Step 108) for resubmission.

The drawbacks of lacking an automatic mechanism to check and control expenses are clear. The above-mentioned conventional process of expense approval takes too much time and energy in personally double-checking the documentation since two steps-by-person are involved in the approval/check flow, thereby reducing efficiency. Presently, there are some conventional ERP systems that provide a function to analyze the incurred expenses for each department and to compare the actual expenses with the original budget. In this system, however, the budget was set to a fixed amount and can not be changed. Therefore, such a fixed budget based on an earlier operation status of the company when the budget was made is not flexible enough to duly reflect the ongoing business operations change (such as a change in workforce numbers), nor can it replace the personal inspection process of the accounting department and nor specify various limitations to individuals of various departments of different departments, positions, titles, etc.

Thus, it is of great importance to solve the above-mentioned problem.

### SUMMARY OF THE INVENTION

The main purpose of the present invention is to provide an automatic inspection method for an expense application. This is done via setting up an expense inspection policy in a computer system that automatically inspects and controls expenses. The double-checking process done by the accounting personnel is no longer required.

Based on one embodiment of the present invention, a method for an expense inspection policy setup in a computer system is provided. The method comprises the following steps: entering the account subject or code for the applied expense; setting the maximum amount for the expense account; setting the period for the accumulation of expenses up to the maximum amount; and, finally, entering the necessary qualifiers for the maximum amount.

The above period for the accumulation of expenses includes the length (duration) and the number of times. The qualification range includes department, title, level, position, employee and all-equal (all the applicants are qualified).

Based on one embodiment of the present invention, an inspection method for the expense application is provided. The process that a computer system follows during an expense inspection procedure is also provided. This procedure comprises these following steps: entering the information for the application of expenses into the computer system, which will inspect the information afterwards; saving it on the computer system and creating a ledger for this application if the applied information is approved, or rejecting it for resubmission if the applied information is not approved.

Moreover, the above-mentioned method comprises the following steps before the expense application information has been entered into the computer system: personal inspection of the expense application; entering the information into the computer system upon approval, or, returning the expense application if it is not approved. In some situation, however, the personal inspection of the expense application can be omitted.

### BRIEF DESCRIPTION OF THE DRAWINGS

FIG. 1 illustrates the flow chart for the conventional expense inspection operation in accordance with one example of the prior art;

FIG. 2 illustrates the “Expense Inspection Policy Set-Up” function of the expense inspection method, as viewed on a screen in accordance with one embodiment of the present invention;

FIG. 3 illustrates the “Qualification” function of the expense inspection method, as viewed on a screen in accordance with an embodiment of the present invention; and

FIG. 4 illustrates the flow chart for the expense inspection operation in accordance with an embodiment of the present invention.

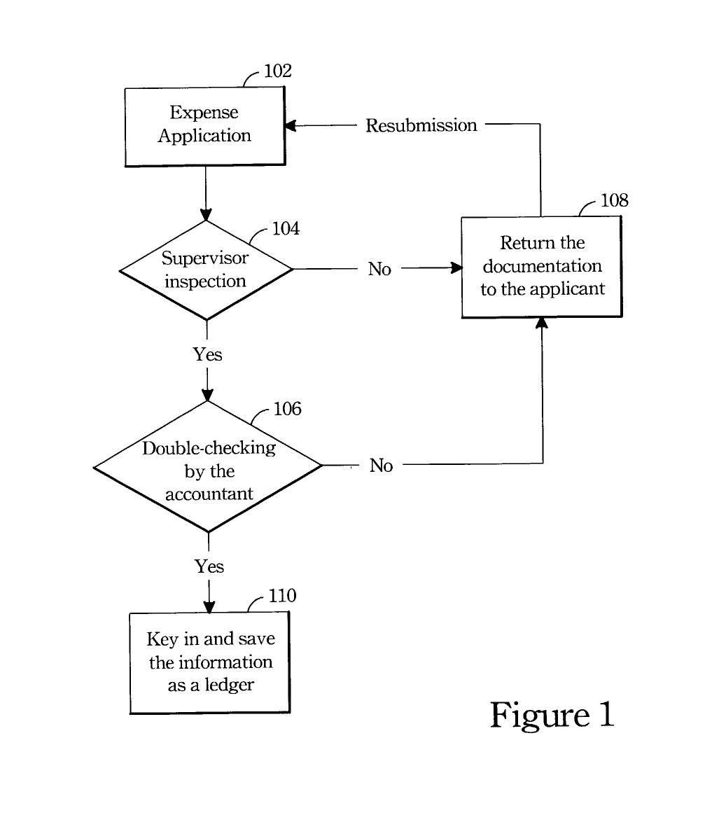

### DETAILED DESCRIPTION OF THE INVENTION

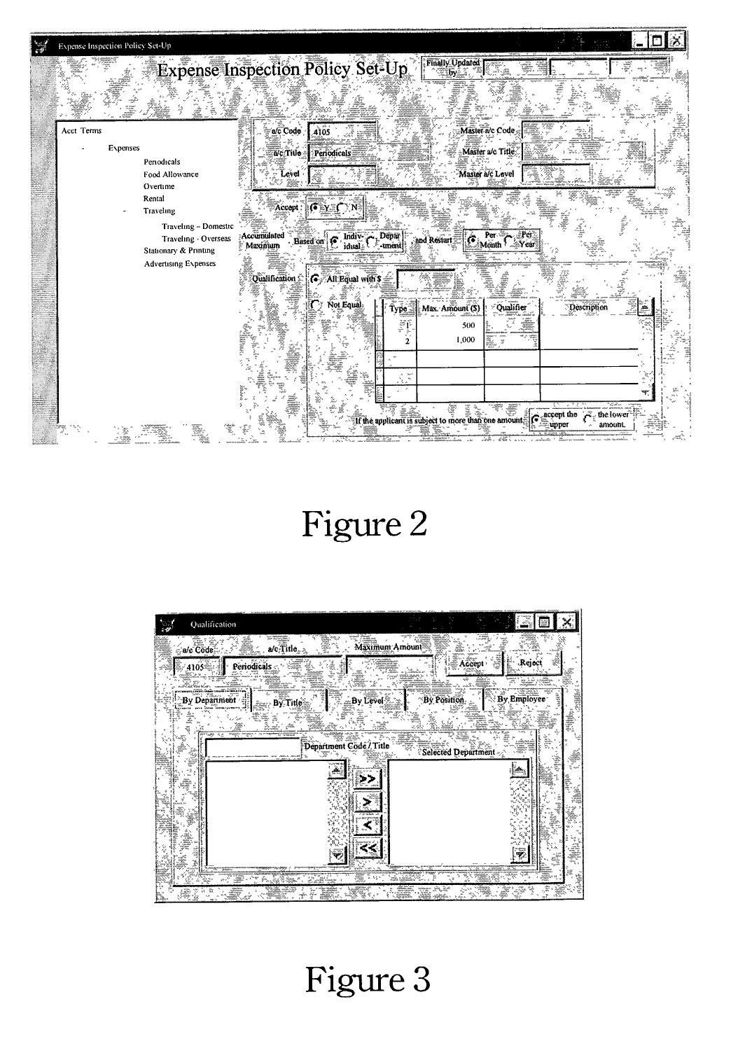

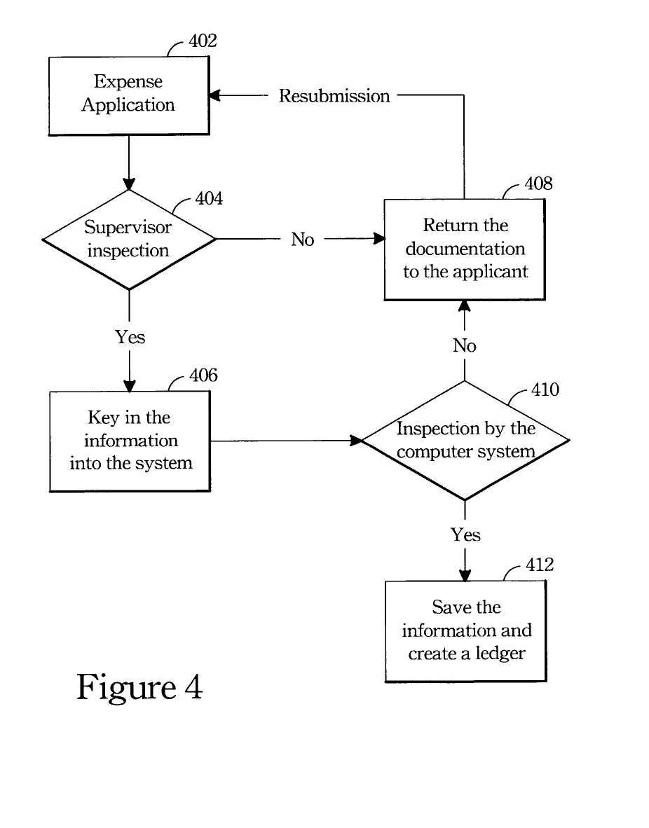

The present invention provides a system for the inspection of expense applications, including the mechanism to set up the expense inspection policy to build the system in a computer (as shown in FIGS. 2 and 3) and the flow to process the inspection of the expense applications through the system (as shown in FIG. 4).

The present invention provides a method for the inspection of expense applications. One preferred embodiment is illustrated below to explain the mechanism of “Expense Inspection Policy Set-Up” for the present invention.

Referring to FIG. 2, the mechanism to set up the expense inspection policy begins with the “Expense Inspection Policy Set-Up” GUI (Graphics User Interface). Through this GUI, a system builder can build up this system for the accounting department according to their request.

A window was provided on the left portion of the GUI showing the possible expense accounts for the builder to select. The possible expense accounts include, for example, periodicals, food allowance, overtime, rental, traveling, stationary and printing, and advertising expenses, etc. In addition, there can be sub-accounts under those accounts, such as domestic traveling and overseas traveling under the traveling account.

An embossed area was provided on the upper center of the GUI showing the expense account selected. The setup of the expense inspection policy is conducted on an account base, i.e., proceeds in accordance with the accounts one by one. When the builder wants to set up the policy, he/she selects an account first. The information relevant to the selected expense account, such as the account code, the account title, will show in the fields of the embossed area.

A block was shown on the right bottom of the GUI for setup of the qualifications of the expense amounts of the selected expense account. In this block, a table is provided to set different maximum amounts for various qualifiers. The table comprises a plurality of records each including a type field, a maximum amount field, a qualifier field, and a description field. When a specific amount is entered into the maximum amount field, the qualifier filed can be set up to decide which employees are qualified for this maximum amount, and this will be further explained in detail later with FIG. 3. Another function is provided in this GUI at a location above this table to decide which employees are applicable to the maximum amount settings. If the selection item “All Equal with $” is selected, an amount is given a blank follows for applying to all employees. Otherwise, the selection item “Not Equal” is selected and the maximum amount setup should be conducted in the above-mentioned table for employees of various qualifications. Still another function is provided in this GUI at a location below this table for the employee to whom more than one maximum amount is applicable. According to this function, the builder can select which of the maximum amount criteria is applied to an employee who is qualified for more than one maximum amount criteria. In the present embodiment, the function is prepared to select either the upper amount or the lower amount of the applicable maximum amounts.

One more function is provided on the center of the GUI: amount accumulation standards setup function. The above-mentioned maximum amount can be set on an individual base or on a department base. In an individual base, when the expense amount of the employee accumulates beyond the maximum amount, the system will reject the application, while in a department base, when the expense amount of a department accumulates beyond the maximum amount, the system will reject the application. In addition, the accumulation period for maximum amount can be set on a monthly base or an annual base. In other words, the expense accumulation can be selectively set to reset by month or by year.

When the maximum amount setup table of the qualification block is set up, under the clicking of the qualifier field, a second GUI, “Qualification” GUI, as shown in FIG. 3, will show up on the screen to decide which employees are qualified to the maximum amount on the same record of the table. On an upper portion of the GUI, the account code, account subject and maximum amount of the selected account appear. The selection of the qualified employee can be conducted by department, title, level, position, or employee, or, by the combination thereof. After clicking the “YES” or confirmation key, the employees qualified to the specific maximum amount in the same record will be specified. With this function, the builder can set various employees of different department, title, level, position, or employee individual but applicable to the same maximum amount at one time.

After completing the setup of the “Expense Inspection Policy Set-Up” and “Qualification” (if any) of all expense accounts, the setup of the present system according to the inspection policy is completed. An example of the setup is introduced below to explain the present invention.

For example, for the controlling of social expenses of the employees, the setup can be conducted on the account “Social Expenses”. Assume the social expenses allowed for a title above that of sales manager is $10,000 (for other sales staff, the maximum amount is $5,000); for a title above that of administration section chief, the maximum amount is $2,000. The setup for such a situation is as follows:

(1) Enter data into the first qualification type of the maximum amount setup table of the qualification block—the maximum amount is $10,000. Click the “Qualifier” field and the “Qualification” GUI will show on the screen. Click the label “By Department” and choose the sales department with titles equal to and above manager, such as manager or senior director.

(2) Enter data into the second record of the table the maximum amount of $5,000. Choose the sales department.

(3) Enter data into the third record of the table the maximum amount of $2,000. Choose the administration department with titles equal to and above section chief, such as section chief, deputy manager, or manager.

(4) On the “Expense Inspection Policy Set-Up” screen, choose “Upper Amount” for a qualified employee subject to more than one maximum amount to complete the set-up process.

With the build-up of the expense inspection policy system in a computer, the present invention can be applied to provide an automatic inspection mechanism for expense applications on the computer. When an amount a certain expense account exceeds its limitation under the expense inspection policy, the user will be prohibited from processing the next steps to save files or create ledgers. This automatically controls the outgoing of expenses and avoids key-in errors or forgery. Furthermore, a computer installed with the present invention system can replace the accountant, necessary for doing a second check. With the exclusion of any expenses above the maximum amount by the inspection system after the approval of the supervisor, the accountant does not have to double-check the application.

After the expense inspection system is built in a computer through the above-mentioned mechanism, the flow to process the inspection of the expense applications through the system is provided as shown in FIG. 4 and explained as follows.

As shown in FIG. 4, the applicant first submits the expense application with attached expense receipts to the department supervisor (Step 402), and then the department supervisor inspects the applied expense (Step 404). If the application is approved by the supervisor, the application information will be entered into the computer system (Step 406); otherwise, the documentation is returned to the applicant (Step 408) for resubmission. After the expense application information is entered into the computer, it will then be inspected by the expense inspection system in accordance with the preset expense inspection policy (Step 410). With the final approval of the expense inspection system, the application information is saved and its ledger is created in the computer system (Step 412); otherwise, the application will be rejected and the documentation is returned to the applicant (Step 408) for resubmission.

In some situation, Step 404 can be omitted. In other words, the expense application can be inspected solely by the computer system rather than by an individual.

Thus, the uniqueness of the present invention and its superiority to the prior art are obvious. The drawbacks it overcomes are described as follows:

(1) The present invention provides a computer system with an expense inspection mechanism that can automatically control the approval of expenses, exclude any amounts above the maximum limit preset by policy, avoid key-in errors or forgery, and replace the need for an accountant in double-checking.

(2) The expense inspection policy provided by the invention can be used to set up the control criteria based on an individual or department expense accumulation and to limit the maximum amount on a monthly base or an annual base. It can further be used to set up different maximum amounts as the control criteria for the same expense account but for various applicants of different department, title, level, position, or employee. When setting up the qualifiers for the same maximum of an expense account, the present invention is flexible so that the builder can specify the criteria according to department, title, level, position, or employee individual, or even the combination thereof. When an inspected applicant is qualified for more than one maximum amount, the system can also be set up to select either the upper amount or the lower amount as the applicable maximum.

It is to be understood that while a certain preferred embodiment of the invention is illustrated, the invention is not limited to what is shown and described in the specification and drawings. Various changes or modifications may be made without departing from the spirit and scope of the invention as set forth in the appended claims.

What is claimed is:

1. An inspection method for approval of an expense application through a computer system, comprising the steps of:
entering data of said expense application into said computer system;
inspecting said expense application data by comparing said data with a plurality of qualification limitations; and
making a decision of whether or not an expense item of said expense application beyond said qualification limitations.

2. The inspection method for approval of an expense application through a computer system according to claim 1, further comprising a step of a supervisor inspection before said step of entering said expense application into said computer system.

3. The inspection method for approval of an expense application through a computer system according to claim 2, wherein said expense application is returned for resubmission in case said expense application is not approved in said expense supervisor inspection.

4. The inspection method for approval of an expense application through a computer system according to claim 2, wherein said data of said expense application is entered into said computer system in case said expense application is approved in said expense supervisor inspection.

5. The inspection method for approval of an expense application through a computer system according to claim 1, wherein said expense application is rejected by the computer system in case an expense item of said expense application is decided to be beyond said qualification limitations.

6. The inspection method for approval of an expense application through a computer system according to claim 1, wherein said expense application is saved in the computer system in case no expense item of said expense application is decided to be beyond said qualification limitations.

7. The inspection method for approval of an expense application through a computer system according to claim 6, further comprising a ledger created in the computer system for said expense application.

8. A method for set up an expense inspection mechanism in a computer system, comprising the steps of:
selecting an expense account;
specifying a maximum amount for said expense account; and
specifying a period for resetting an accumulated expanse amount in said account with said maximum amount.

9. A method for set up an expense inspection mechanism in a computer system according to claim 8, further comprising the step of specifying qualifications for applicants subject to said maximum amount of said expense account after the step of selecting an expense account.

10. A method for set up an expense inspection mechanism in a computer system according to claim 9, wherein said step of specifying qualifications for applicants subject to said maximum amount of said expense account comprises specifying qualifications by at lease one of the following attributes: department, title, level, position, or employee individual.

11. A method for set up an expense inspection mechanism in a computer system according to claim 8, wherein said step of specifying a period for resetting the accumulated expanse amount in said expanse account with said maximum amount comprises resetting the accumulated expanse amount by month or by year.

12. A method for set up an expense inspection mechanism in a computer system according to claim 8, further comprising the step of specifying whether said specified maximum amount is applicable to all employees.

13. A method for set up an expense inspection mechanism in a computer system according to claim 8, further comprising the step of specifying which of the maximum amounts is to apply when an applicant is qualified for more than one maximum amount.

14. A method for set up an expense inspection mechanism in a computer system according to claim 8, further comprising the step of specifying the calculation base by which the expanse amount accumulates in said expanse account with said maximum amount is either by department or by individual.

15. A method for set up an expense inspection mechanism in a computer system, comprising:
providing a graphics user interface on a screen including a selected expense account therein;
providing in the graphics user interface a function to specify a maximum amount for said expense account; and
providing in the graphics user interface a function to specify at least one qualification for said maximum amount with said expanse account.

16. A method for set up an expense inspection mechanism in a computer system according to claim 15, further comprising providing in the graphics a function to specify a period for resetting an accumulated expanse amount in said expanse account with said maximum amount:

17. A method for set up an expense inspection mechanism in a computer system according to claim 15, further comprising providing in the graphics user interface a function to specify whether said specified maximum amount is applicable to all employees.

18. A method for set up an expense inspection mechanism in a computer system according to claim 15, further comprising providing in the graphics user interface a function to specify the calculation base by which the expanse amount accumulates in said expanse account with said maximum amount is either by department or by individual.

19. A method for set up an expense inspection mechanism in a computer system according to claim 15, further comprising providing in the graphics user interface a function to specify said at least one qualification for applicants subject to said maximum amount of said expense account by at lease one of the following attributes: department, title, level, position, or employee individual.

20. A method for set up an expense inspection mechanism in a computer system according to claim 15, further comprises a function of specifying which of the maximum amounts is to apply when an applicant is qualified for more than one maximum amount.
